(19) United States
(12) Patent Application Publication
(10) Pub. No.: US 2026/0280109 A1
(43) Pub. Date: Sep. 17, 2026

(54) VIBRATION ANTENNA DEVICE, VIBRATION ANTENNA DEVICE ARRAY, AND ELECTRONIC APPARATUS

(71) Applicant: SONY GROUP CORPORATION, TOKYO (JP)

(72) Inventors: TAKUMA MATSUSHITA, TOKYO (JP); TAKASHI KAWAMURA, TOKYO (JP)

(21) Appl. No.: 19/162,148

(22) PCT Filed: Jan. 22, 2024
(86) PCT No.: PCT/JP2024/001561

§ 371 Date: Sep. 4, 2025

Related U.S. Application Data
(60) Provisional application No. 63/491,847, filed on Mar. 23, 2023.

(51) Int. Cl. H01Q 1/38; H02J 50/00; H02J 50/15

(52) U.S. Cl. CPC H01Q 1/38; H02J 50/001; H02J 50/15

(57) ABSTRACT

A vibration antenna device according to an embodiment of the present technology includes: a piezoelectric layer; a pair of electrodes; and a magnetic layer. The piezoelectric layer is at least partially formed of a piezoelectric material and vibrates in a predetermined vibration direction. The pair of electrodes face each other across the piezoelectric layer. The magnetic layer is at least partially formed of a magnetic material, is adjacent to the piezoelectric layer in a direction perpendicular to the vibration direction, and has an easy axis direction and a hard axis direction positioned in a plane parallel to the vibration direction.

### TECHNICAL FIELD

The present technology relates to a vibration antenna device, a vibration antenna device array, and an electronic apparatus that transmit/receive electromagnetic waves.

### BACKGROUND ART

Electronic apparatuses such as wireless earphones are equipped with antennas that transmit/receive electromagnetic waves, and the size and arrangement of general antennas that use a copper foil or the like are becoming problematic as the electronic apparatuses are miniaturized. In recent years, ME (Magnetoelectric) antennas have been developed as antennas suitable for miniaturization.

The ME antenna includes a magnetic layer formed of a magnetic material stacked on a piezoelectric resonator formed of a piezoelectric material (see, for example, Non-Patent Literature 1). When a voltage is applied to vibrate the piezoelectric resonator, a magnetic field is generated around the magnetic layer due to the Villari effect, and electromagnetic waves are emitted. Further, when electromagnetic waves enter the magnetic layer, magnetostriction occurs in the magnetic layer due to the Joule effect, and a voltage is generated in the piezoelectric resonator. The ME antenna is configured to be capable of transmitting/receiving electromagnetic waves in this way, and in principle, the antenna size can be significantly reduced.

### CITATION LIST

### Non-Patent Literature

Non-Patent Literature 1 Tianxiang Nan, et al., “Acoustically actuated ultra-compact NEMS magnetoelectric antennas”, NATURE COMMUNICATIONS 8: 296, DOI: 10.1038/s41467-017-00343-8

### DISCLOSURE OF INVENTION

### Technical Problem

However, in the ME antenna described in Non-Patent Literature 1, the operation of the magnetic layer is inefficient due to the relationship between the vibration direction of the piezoelectric resonator and the magnetization direction of the magnetic layer, resulting in insufficient antenna properties when used alone.

In view of the circumstances as described above, it is an object of the present technology to provide a vibration antenna device, a vibration antenna device array, and an electronic apparatus that are suitable for miniaturization and have excellent antenna properties.

### Means for Solving the Problem

In order to achieve the above-mentioned object, a vibration antenna device according to an embodiment of the present technology includes: a piezoelectric layer; a pair of electrodes; and a magnetic layer.

The piezoelectric layer is at least partially formed of a piezoelectric material and vibrates in a predetermined vibration direction.

The pair of electrodes face each other across the piezoelectric layer.

The magnetic layer is at least partially formed of a magnetic material, is adjacent to the piezoelectric layer in a direction perpendicular to the vibration direction, and has an easy axis direction and a hard axis direction positioned in a plane parallel to the vibration direction.

The hard axis direction of the magnetic layer may match the vibration direction.

The magnetic material may be a material having a positive magnetostriction constant, and the easy axis direction may be perpendicular to the vibration direction.

The magnetic material may be a material having a negative magnetostriction constant, and the easy axis direction may be parallel to the vibration direction.

The vibration antenna device may further include a plurality of the piezoelectric layers and a plurality of the magnetic layers, the plurality of piezoelectric layers and the plurality of magnetic layers being alternately arranged in the direction perpendicular to the vibration direction.

The plurality of magnetic layers may include the magnetic layer having the hard axis direction that matches a first direction parallel to the vibration direction and the magnetic layer having the hard axis direction that matches a second direction, the second direction being parallel to the vibration direction and opposed to the first direction.

The piezoelectric layer may have a polarization direction in a first direction that is parallel to the vibration direction or a second direction that is parallel to the vibration direction and opposed to the first direction.

The pair of electrodes may face each other with the vibration direction as an opposing direction.

The piezoelectric layer may have a plate-like shape whose main surface is parallel to the vibration direction, and
the magnetic layer may have a plate-like shape whose main surface is parallel to the vibration direction.

The vibration antenna device may include a plurality of layers stacked in the vibration direction, each of the plurality of layers including the plurality of piezoelectric layers and the plurality of magnetic layers alternately arranged in the direction perpendicular to the vibration direction.

The vibration antenna device may further include an interlayer insulation layer that is formed of an insulating material and arranged between the plurality of layers.

The vibration antenna device may be formed on a substrate whose main surface is a plane perpendicular to the vibration direction.

The vibration antenna device may be formed on a substrate whose main surface is a plane parallel to the vibration direction.

The magnetic layer may further include a plurality of magnetic films that is formed of a magnetic material and an insulation layer that is formed of an insulation material and arranged between he plurality of magnetic films.

The pair of electrodes may be formed of a magnetic material.

The pair of electrodes may face each other further across the magnetic layer.

The vibration antenna device may be provided on a substrate in which an acoustic mirror is provided and adjacent to the acoustic mirror.

The vibration antenna device may be provided on a substrate in which a gap is provided and adjacent to the gap.

In order to achieve the above-mentioned object, a vibration antenna device array according to an embodiment of the present technology includes: a plurality of vibration antenna devices.

Each of the vibration antenna devices includes a piezoelectric layer that is at least partially formed of a piezoelectric material and vibrates in a predetermined vibration direction, a pair of electrodes that face each other across the piezoelectric layer, and a magnetic layer that is at least partially formed of a magnetic material, is adjacent to the piezoelectric layer in a direction perpendicular to the vibration direction, and has an easy axis direction and a hard axis direction positioned in a plane parallel to the vibration direction, and
the pair of electrodes are electrically connected between the plurality of vibration antenna devices.

In order to achieve the above-mentioned object, a vibration antenna device array according to an embodiment of the present technology includes: a plurality of vibration antenna devices.

In order to achieve the above-mentioned object, an electronic apparatus according to an embodiment of the present technology includes: a vibration antenna device.

The vibration antenna device includes a piezoelectric layer that is at least partially formed of a piezoelectric material and vibrates in a predetermined vibration direction, a pair of electrodes that face each other across the piezoelectric layer, and a magnetic layer that is at least partially formed of a magnetic material, is adjacent to the piezoelectric layer in a direction perpendicular to the vibration direction, and has an easy axis direction and a hard axis direction positioned in a plane parallel to the vibration direction.

### BRIEF DESCRIPTION OF DRAWINGS

FIG. 1 is a schematic diagram of a general vibration antenna device.

FIG. 2 is a schematic diagram showing an ideal operation of the above vibration antenna device.

FIG. 3 is a schematic diagram showing an actual operation of the above vibration antenna device.

FIG. 4 is a perspective view of a vibration antenna device according to this embodiment.

FIG. 5 is a perspective view showing a partial configuration of the above vibration antenna device.

FIG. 6 is a schematic diagram showing an operation of a piezoelectric layer of the above vibration antenna device.

FIG. 7 is a schematic diagram showing an easy axis direction and a hard axis direction in a magnetic layer of the above vibration antenna device.

FIG. 8 is a schematic diagram showing the easy axis direction and the hard axis direction in the magnetic layer of the above vibration antenna device.

FIG. 9 is a schematic diagram showing the transmission operation of the above vibration antenna device.

FIG. 10 is a schematic diagram showing the reception operation of the above vibration antenna device.

FIG. 11 is a schematic diagram showing the hard axis direction in the magnetic layer of the above vibration antenna device.

FIG. 12 is a schematic diagram showing the hard axis direction in the magnetic layer of the above vibration antenna device.

FIG. 13 is a plan view showing the plane shape of the above vibration antenna device.

FIG. 14 is a plan view showing the plane shape of the above vibration antenna device.

FIG. 15 is a plan view showing the plane shape of the above vibration antenna device.

FIG. 16 is a schematic diagram showing the electrical connection of the above vibration antenna device.

FIG. 17 is a schematic diagram showing the electrical connection of the above vibration antenna device.

FIG. 18 is a schematic diagram showing a vibration antenna device having another structure according to this embodiment.

FIG. 19 is a plan view showing the plane shape of the above vibration antenna device.

FIG. 20 is a plan view showing the plane shape of the above vibration antenna device.

FIG. 21 is a plan view showing the plane shape of the above vibration antenna device.

FIG. 22 is a plan view showing the plane shape of the above vibration antenna device.

FIG. 23 is a cross-sectional view of the above vibration antenna device.

FIG. 24 is a schematic diagram of a vibration antenna device having another structure according to this embodiment.

FIG. 25 is a schematic diagram of a vibration antenna device having another structure according to this embodiment.

FIG. 26 is a schematic diagram of a vibration antenna device having a layered structure according to this embodiment.

FIG. 27 is a schematic diagram of the above vibration antenna device.

FIG. 28 is a schematic diagram of a vibration antenna device having a layered structure according to this embodiment.

FIG. 29 is a schematic diagram of the above vibration antenna device.

FIG. 30 is a perspective view of a vibration antenna device according to this embodiment, which is provided on a substrate.

FIG. 31 is a perspective view of a vibration antenna device according to this embodiment, which is provided on a substrate.

FIG. 32 is a perspective view of a vibration antenna device according to this embodiment, which is provided adjacent to an acoustic mirror layer.

FIG. 33 is a cross-sectional view of the above vibration antenna device.

FIG. 34 is a perspective view of a vibration antenna device according to this embodiment, which is provided adjacent to an acoustic mirror.

FIG. 35 is a perspective view of a vibration antenna device according to this embodiment, which is provided adjacent to an acoustic mirror.

FIG. 36 is a perspective view of a vibration antenna device according to this embodiment, which is provided adjacent to a gap.

FIG. 37 is a perspective view of a vibration antenna device according to this embodiment, which is provided adjacent to a gap.

FIG. 38 is a perspective view of a vibration antenna device according to this embodiment, which is provided adjacent to a gap.

FIG. 39 is a perspective view of a vibration antenna device according to this embodiment, which is provided adjacent to an acoustic mirror and a gap.

FIG. 40 is a schematic diagram of a vibration antenna device array according to this embodiment.

### MODE(S) FOR CARRYING OUT THE INVENTION

### Principle of Vibration Antenna

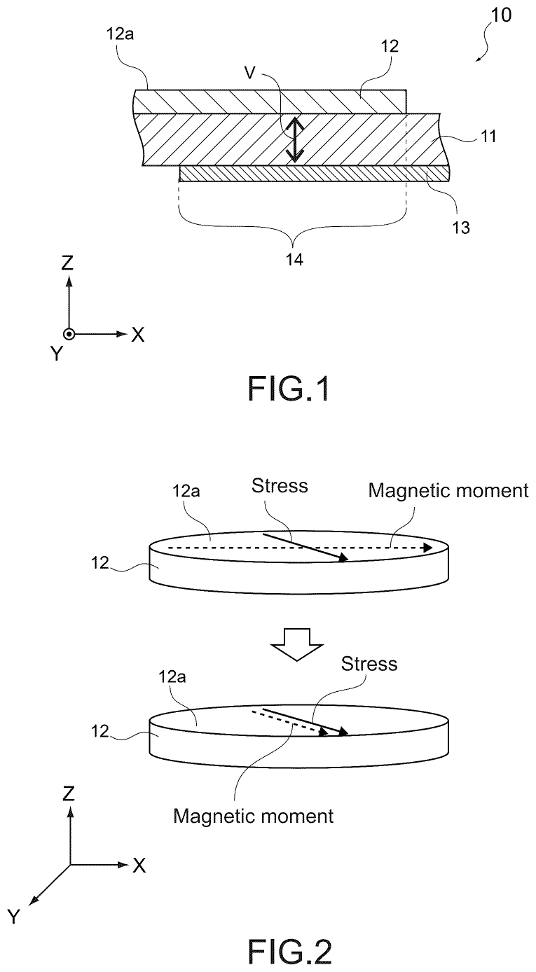

The principle of a vibration antenna device according to this embodiment will be described. FIG. 1 is a schematic diagram showing a configuration of a vibration antenna device 10. The vibration antenna device 10 is an ME (Magnetoelectric) antenna device and includes a piezoelectric layer 11, a magnetic layer 12, and an electrode 13, as shown in the figure. Note that the configuration of the vibration antenna device 10 shown in FIG. 1 is different from the configuration of the vibration antenna device according to the present technology.

The piezoelectric layer 11 is a layer formed of a piezoelectric material. The magnetic layer 12 is formed of a magnetic material and stacked on the piezoelectric layer 11. The main surface of the magnetic layer 12 is shown as a main surface 12a. The electrode 13 is stacked on the piezoelectric layer 11 on the side opposite to the magnetic layer 12. The magnetic layer 12 faces the electrode 13 via the piezoelectric layer 11 and functions also as another electrode. The portion of the piezoelectric layer 11 sandwiched between the electrode 13 and the magnetic layer 12 constitutes a resonant portion 14. The resonant portion 14 is formed in, for example, a disc shape.

In the case where electromagnetic waves are transmitted using this vibration antenna device 10, a signal is supplied to the vibration antenna device 10, i.e., a voltage is applied between the magnetic layer 12 and the electrode 13. As a result, the piezoelectric layer 11 of the resonant portion 14 vibrates due to the inverse piezoelectric effect, causing resonance in the resonant portion 14. In FIG. 1, the vibration caused by resonance is shown as a vibration V. This vibration V causes the Villari effect in the magnetic layer 12, and the strength of magnetization of the magnetic layer 12 changes periodically. This causes a magnetic field to be generated around the magnetic layer 12, thereby emitting electromagnetic waves.

Meanwhile, in the case where electromagnetic waves are received using the vibration antenna device 10, when electromagnetic waves enter the magnetic layer 12, magnetostriction occurs in the magnetic layer due to the Joule effect, causing the vibration V in the resonant portion 14 due to resonance. This vibration V generates a voltage in the piezoelectric layer 11 of the resonant portion 14 due to the positive piezoelectric effect, and a signal is output from the electrode 13.

FIG. 2 is a schematic diagram showing an ideal magnetic moment, i.e., the relationship between the orientation of the magnetic force and the stress, in the magnetic layer 12 of the resonant portion 14. In FIG. 2(a), the magnetic moment indicated a broken arrow is directed toward the in-plane direction of the main surface 12a. Here, as shown by a solid arrow in FIG. 2(a), when stress in the in-plane direction of the main surface 12a is applied to the magnetic layer 12, the magnetic moment moves to be directed toward the same direction as the stress within the same plane as shown in FIG. 2(b). This forms a magnetic dipole, and electromagnetic waves are emitted from the magnetic layer 12.

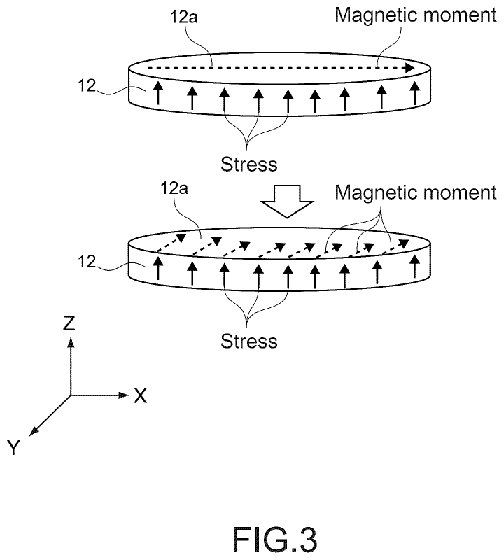

Meanwhile, FIG. 3 is a schematic diagram showing the relationship between the actual magnetic moment and stress in the magnetic layer 12 of the resonant portion 14. In FIG. 3(a), the magnetic moment indicated by a broken arrow is directed toward the in-plane direction of the main surface 12a. At this time, when the piezoelectric layer 11 vibrates due to the inverse piezoelectric effect, the stress applied to the magnetic layer 12 from the piezoelectric layer 11 becomes stress in a direction perpendicular to the main surface 12a as shown by a solid arrow in FIG. 3(a). In this case, as shown in FIG. 3(b), the magnetic moment moves in a direction away from the in-plane of the main surface 12a, and thus, the magnetization is weakened by the demagnetizing field of the magnetic layer 12. As a result, the intensity of electromagnetic waves emitted from the magnetic layer 12 becomes smaller than that in the above ideal case, and the operation efficiency of the vibration antenna device 10 decreases. Specifically, a twofold difference in power conversion occurs and the antenna properties are insufficient when using the vibration antenna device 10 alone.

In the vibration antenna according to this embodiment shown below, it is possible to achieve the ideal relationship between the magnetic moment and the stress shown in FIG. 2, and improve the operation efficiency of the vibration antenna.

### Configuration of Vibration Antenna Device

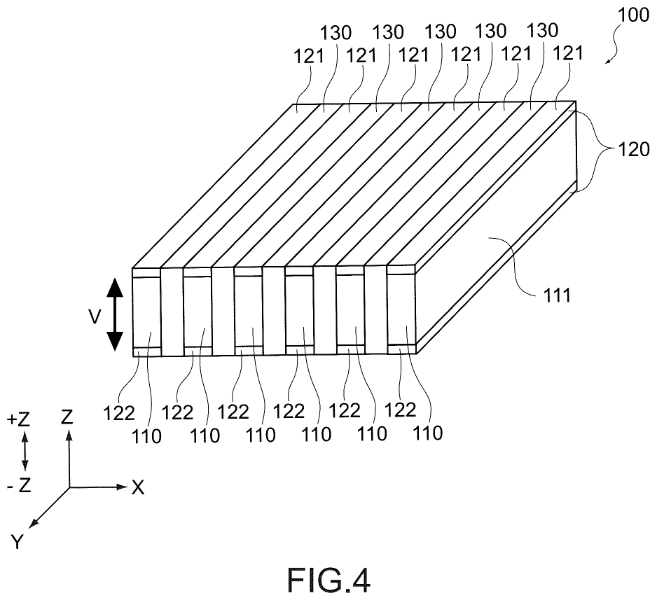

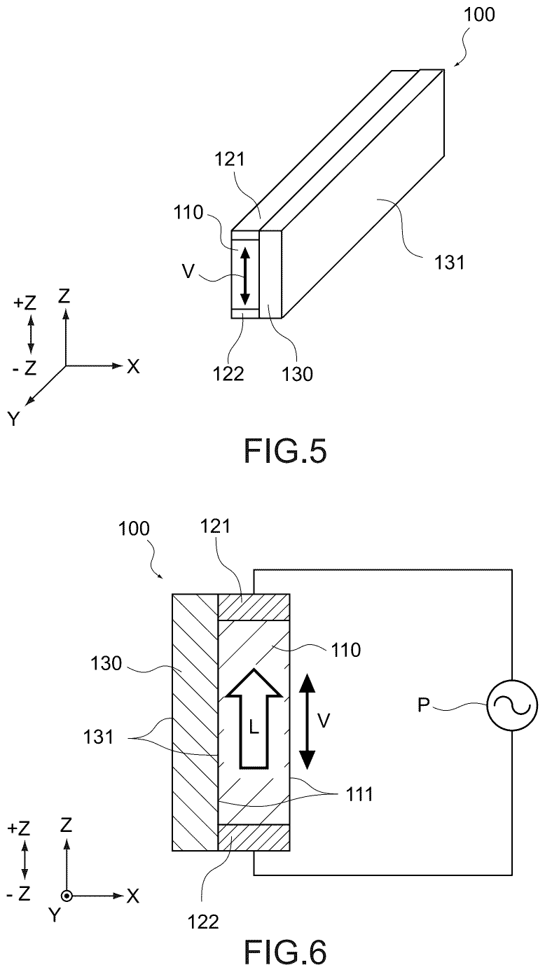

The configuration of a vibration antenna device according to this embodiment will be described. FIG. 4 is a perspective view showing a vibration antenna device 100 according to this embodiment, and FIG. 5 is a perspective view of a partial configuration of the vibration antenna device 100. FIG. 6 is a schematic diagram of a partial configuration of the vibration antenna device 100.

As shown in these figures, the vibration antenna device 100 includes a piezoelectric layer 110, an electrode 120, and a magnetic layer 130. The electrode 120 includes an upper electrode 121 and a lower electrode 122. Hereinafter, the thickness direction of the vibration antenna device 100 will be referred to as a Z-axis direction, one direction perpendicular to the Z-axis direction will be referred to as an X-axis direction, and a direction perpendicular to the Z-axis direction and the X-axis direction will be referred to as a Y-axis direction. The Z-axis direction includes a +Z direction and a −Z direction, and these are opposite to each other in the Z-axis direction.

The piezoelectric layer 110 is a layer that generates vibration by the piezoelectric effect and generates polarization by the positive piezoelectric effect. The piezoelectric layer 110 is a layer that is at least partially formed of a piezoelectric material. As the piezoelectric material, aluminum nitride (AlN), scandium aluminum nitride (AlScN), lithium niobate/lithium tantalate (LN/LT; LiNbO₃/LiTaO₃), lead zinc niobate-lead titanate/lead magnesium zincate-lead titanate (PZNT/PMZT; Pb (Zn_{1/3}Nb_{2/3})_{1-X}Ti_{X}O₃/Pb(Mg_{1/3}Zr_{2/3})_{1-Y}Ti_{Y}O₃), lead zirconate titanate (PZT; Pr(ZrTi)O₃), lead titanate (PbTiO₃), lead niobate (PbNb₂O₆), barium titanate (BaTiO₃), bismuth titanate (Bi₄Ti₃O₁₂), sodium bismuth titanate (Bi, Na)TiO₃, potassium sodium niobate (KNN; (K, Na)NbO₃), zinc oxide (ZnO), polyvinylidene fluoride (PVDF), polylactic acid (PLA), or the like can be used.

As shown by an arrow L in FIG. 6, the piezoelectric layer 110 is polarized in the Z-axis direction. The polarization direction of the piezoelectric layer 110 may be the +Z direction or −Z direction as shown in the figure. The polarization direction of the piezoelectric layer 110 is determined by crystal-orientation or voltage application in accordance with the type of piezoelectric material, and thus, the piezoelectric layer 110 is arranged such that the polarization direction is the Z-axis direction in accordance therewith. Since the polarization direction of the piezoelectric layer 110 is the Z-axis direction, when a voltage is applied between the upper electrode 121 and the lower electrode 122 by a power source P, the piezoelectric layer 110 vibrates with the Z-axis direction as the vibration direction as shown by an arrow V.

As shown in FIG. 6, the piezoelectric layer 110 can have a plate-like shape in which a main surface 111 is parallel to the vibration direction (Z-axis direction). The shape of the main surface 111 may be a rectangular shape or any other shape. The thickness (Z-axis direction) of the piezoelectric layer 110 along the vibration direction is suitably one-half or one-quarter of the elastic wave wavelength formed in the vibration antenna device 100. The width (X-axis direction) and length (Y-axis direction) of the piezoelectric layer 110 are not particularly limited. For example, the width (X-axis direction) is several tens of um and the length (Y-axis direction) is several hundreds to several thousands of um.

The configuration of the piezoelectric layer 110 is not limited to the one shown here as long as it vibrates with the Z-axis direction as the vibration direction when a voltage is applied between the upper electrode 121 and the lower electrode 122. For example, the piezoelectric layer 110 may include a plurality of layers formed of different piezoelectric materials. Further, the piezoelectric layer 110 may include a piezoelectric layer and a layer formed of a material other than the piezoelectric material.

As described above, the electrode 120 includes the upper electrode 121 and the lower electrode 122. The upper electrode 121 and the lower electrode 122 face each other via the piezoelectric layer 110, and the opposing direction is the vibration direction (Z-axis direction) of the piezoelectric layer 110. The upper electrode 121 and the lower electrode 122 are formed of a conductive material. As the conductive material, any of manganese (Mn), bismuth (Bi), cesium (Ce), barium (Ba), yttrium (Y), zirconium (Zr), antimony (Sb), hafnium (Hf), uranium (U), strontium (Sr), lead (Pb), rhenium (Re), tungsten (W), osmium (Os), iridium (Ir), platinum (Pt), ruthenium (Ru), molybdenum (Mo), rhodium (Rh), gold (Au), sodium (Na), magnesium (Mg), calcium (Ca), aluminum (Al), silver (Ag), copper (Cu), iron (Fe), niobium (Nb), or an alloy or the like of one or more of these can be used.

Further, one or both of the upper electrode 121 and the lower electrode 122 may be formed of a magnetic material. This magnetic material may be different from or the same as the material of the magnetic layer 130 described below.

The magnetic layer 130 is a layer that emits electromagnetic waves by the Villari effect and generates vibration by the Joule effect. The magnetic layer 130 is at least partially formed of a magnetic material. As the magnetic material, a terbium-dysprosium-iron (TbDyFe) alloy (product name: Terfenol-D), an yttrium-iron-garnet (YIG; Y₃Fe₂(FeO₄)₃/Y₃Fe₅O₁₂), a nickel—iron (NiFe) alloy, an iron—cobalt—boron (FeCoB) alloy, an iron—gallium (FeGa) alloy, an iron—cobalt—silicon—boron (FeCoSiB) alloy, an iron—gallium—carbon (FeGaC) alloy, an iron—gallium—boron (FeGaB) alloy, or the like can be used.

As shown in FIG. 4, the magnetic layer 130 is adjacent to the piezoelectric layer 110 in the direction (X-axis direction) perpendicular to the vibration direction (Z-axis direction) of the piezoelectric layer 110. Specifically, the magnetic layer 130 is provided such that a main surface 131 (see FIG. 5) is in contact with the main surface 111 of the adjacent piezoelectric layer 110. The entire surface of the main surface 131 does not necessarily need to be in contact with the main surface 111, but a larger contact area is suitable.

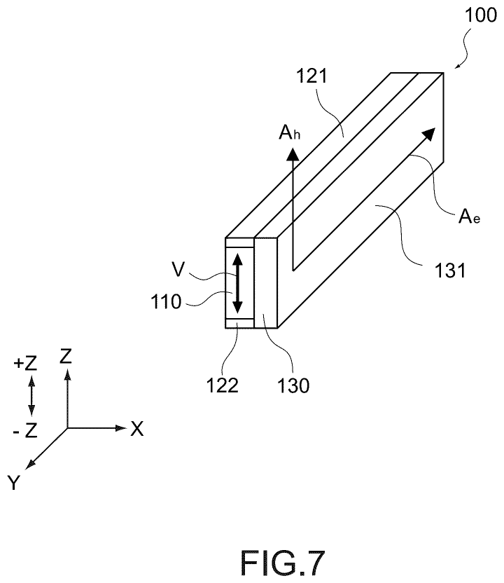

The magnetic layer 130 has an easy axis direction and a hard axis direction. FIG. 7 is a schematic diagram showing an easy axis direction Aₑ and a hard axis direction Aₕ of the magnetic layer 130 in the magnetic layer 130. The easy axis direction Aₑ is the direction in which the demagnetizing field is weakest in the magnetic layer 130, and in other words, the direction of the residual magnetization. The hard axis direction Aₕ is the direction in which the demagnetizing field is strongest in the magnetic layer 130. The magnetic moment of the magnetic layer 130, i.e., the orientation of magnetic force is initially directed toward the easy axis direction Aₑ, but the orientation changes to the hard axis direction Aₕ when stress is applied to the magnetic layer 130.

The magnetic layer 130 is configured such that the easy axis direction Aₑ and the hard axis direction Aₕ are positioned in a Y-Z plane that is a plane parallel to the vibration direction (Z-axis direction) of the piezoelectric layer 110. The easy axis direction Aₑ and the hard axis direction Aₕ are determined by the crystal-orientation of the magnetic layer 130, and thus, the magnetic layer 130 is arranged in an orientation that the easy axis direction Aₑ and the hard axis direction Aₕ are in the Y-Z plane.

Specifically, the magnetic layer 130 is configured such that the hard axis direction Aₕ matches the vibration direction (Z-axis direction) of the piezoelectric layer 110. The hard axis direction Aₕ may match the +Z direction or the −Z direction. Note that the hard axis direction Aₕ suitably completely match the vibration direction (Z-axis direction) of the piezoelectric layer 110, but may be slightly offset. The range of the allowable offset is ±45° in the Y-Z plane.

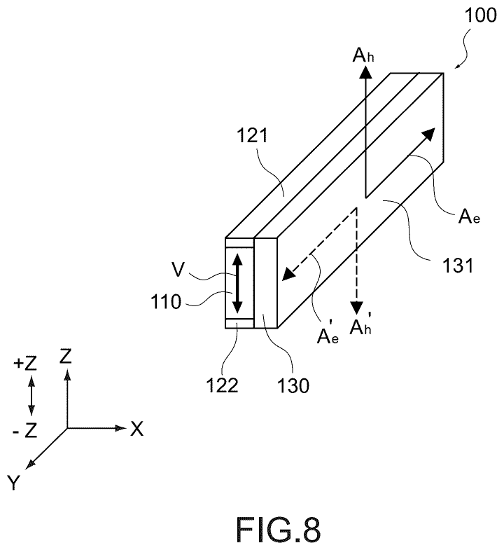

The easy axis direction Aₑ and the hard axis direction Aₕ will be described more specifically. FIG. 8 is a schematic diagram showing the easy axis direction Aₑ and the hard axis direction Aₕ in the case where the magnetic layer 130 has a positive or negative magnetostriction constant. As shown in the figure, the magnetic layer 130 is configured such that the easy axis direction Aₑ is parallel to the main surface 131 and perpendicular (Y-axis direction) to the vibration direction (Z-axis direction) of the piezoelectric layer 110. At this time, the hard axis direction An faces in the +Z direction. Further, as shown in the figure, the magnetic layer 130 may have the easy axis direction Aₑ that is opposite in the Y-axis direction (in the figure, the easy axis direction Aₑ′). At this time, the hard axis direction Aₕ (in the figure, an easy axis direction Ah′) faces in the −Z direction.

In addition, the magnetic layer 130 only needs to be configured such that the easy axis direction Aₑ and the hard axis direction Aₕ are positioned in the Y-Z plane that is a plane parallel to the vibration direction (Z-axis direction) of the piezoelectric layer 110. In the magnetic layer 130, it is suitable that the hard axis direction Aₕ is close to the vibration direction (Z-axis direction) of the piezoelectric layer 110, and it is more suitable that the hard axis direction Aₕ matches the same direction (Z-axis direction).

As shown in FIG. 6, the magnetic layer 130 can have a plate-like shape in which the main surface 131 is parallel to the vibration direction (Z-axis direction). The shape of the main surface 131 may be a rectangular shape or any other shape. The thickness (Z-axis direction), width (X-axis direction), and length (Y-axis direction) of the magnetic layer 130 along the vibration direction are not particularly limited. For example, the thickness (Z-axis direction) is several to several tens of μm, the width (X-axis direction) is several tens of μm, and the length (Y-axis direction) is several hundreds to several thousands of μm.

The configuration of the magnetic layer 130 is not limited to the one shown here as long as the easy axis direction Aₑ and the hard axis direction Aₕ are positioned in the Y-Z plane. For example, the magnetic layer 130 may include a plurality of magnetic layers formed of different magnetic materials. Further, the magnetic layer 130 may have a portion formed of a material other than the magnetic material as described below.

As shown in FIG. 4, the vibration antenna device 100 includes a plurality of piezoelectric layers 110 and a plurality of magnetic layers 130, and these are alternately arranged in the direction (X-axis direction) perpendicular to the vibration direction (Z-axis direction) of the piezoelectric layer 110. That is, each of the piezoelectric layers 110 excluding those on both ends is sandwiched between two magnetic layers 130, and each of the magnetic layers 130 excluding those on both ends is sandwiched between two piezoelectric layers 110. One pair of electrodes 120 are provided for each of the piezoelectric layers 110 so as to sandwich each piezoelectric layer 110. Note that the vibration antenna device 100 only needs to include one or more piezoelectric layers 110 and one or more magnetic layers 130, and may include one piezoelectric layer 110 and one magnetic layer 130.

### Operation of Vibration Antenna Device

The operation of the vibration antenna device 100 will be described. The vibration antenna device 100 is capable of transmitting and receiving electromagnetic waves.

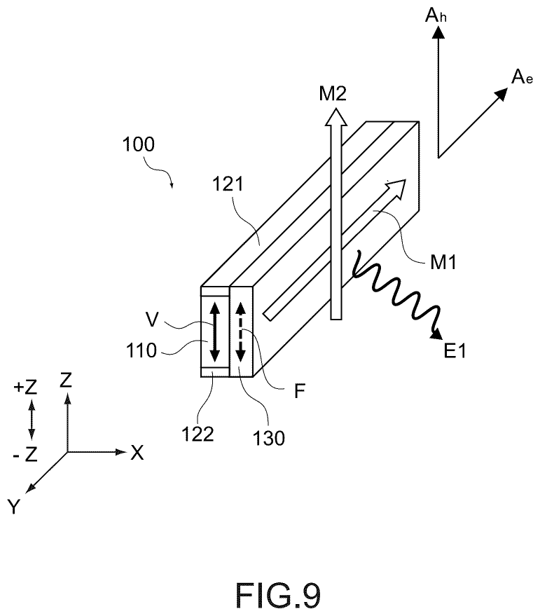

FIG. 9 is a schematic diagram showing transmission of electromagnetic waves by the vibration antenna device 100. When a signal is supplied to the vibration antenna device 100 by the power source P (see FIG. 6), i.e., a voltage is applied between the upper electrode 121 and the lower electrode 122, the vibration V in the Z-axis direction by the inverse piezoelectric effect is generated in the piezoelectric layer 110. This vibration V causes the vibration antenna device 100 to resonate, forming an elastic wave in the vibration antenna device 100. A stress F in the Z-axis direction is applied to the magnetic layer 130 adjacent to the piezoelectric layer 110 from the piezoelectric layer 110. This stress F causes the Villari effect, and the strength of magnetization of the magnetic layer 130 changes periodically to the +Z direction and the −Z direction. As a result, a magnetic field is generated around the magnetic layer 130, and an electromagnetic wave E1 is emitted.

Here, a magnetic moment M1 of the magnetic layer 130 is initially directed toward the easy axis direction Aₑ of the magnetic layer 130. When a signal is supplied to the vibration antenna device 100 and the vibration V occurs in the piezoelectric layer 110, the stress F1 in the Z-axis direction is applied to the magnetic layer 130. This stress F1 causes the magnetic moment M1 to be oriented toward the hard axis direction Aₑ (Z-axis direction) and change to a magnetic moment M2. As a result, the direction of the magnetic moment M2 matches the direction of the stress F. Thus, the magnetization by the Villari effect is not cancelled out by the demagnetizing field and the decrease in the operation efficiency is prevented.

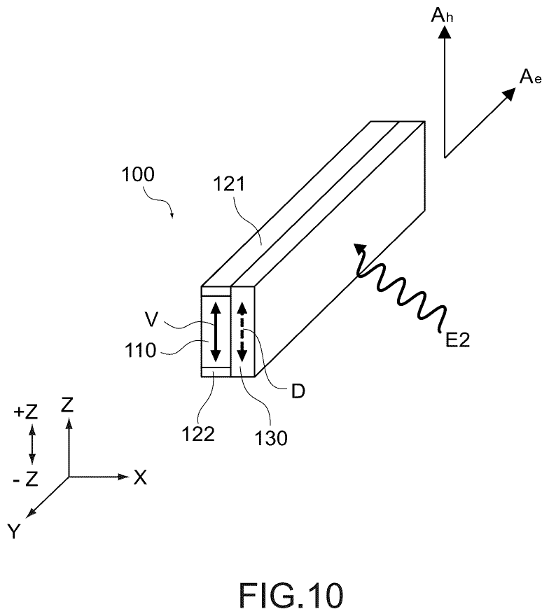

FIG. 10 is a schematic diagram showing reception of electromagnetic waves by the vibration antenna device 100. When an electromagnetic wave E2 enters the vibration antenna device 100 from the outside, a magnetostriction D occurs in the magnetic layer 130 by the Joule effect, and the magnetostriction D causes the vibration antenna device 100 to resonate. The vibration V also occurs in the piezoelectric layer 110 by the resonance, and polarization is generated in the piezoelectric layer 110 by the positive piezoelectric effect. As a result, a voltage is generated between the upper electrode 121 and the lower electrode 122, thereby generating a signal.

As described above, the vibration antenna device 100 is capable of transmitting and receiving electromagnetic waves. The electromagnetic waves transmitted and received by the vibration antenna device 100 are not particularly limited, and are, for example, radio waves at a frequency of 2.45 GHz used in Bluetooth (registered trademark) or the like.

### Effects of Vibration Antenna Device

As described above, in the vibration antenna device 100, the easy axis direction Aₑ and the hard axis direction Aₕ of the magnetic layer 130 are positioned in the plane (Y-Z plane) parallel to the vibration direction (Z-axis direction) of the piezoelectric layer 110. As a result, the magnetization in the magnetic layer 130 by the Villari effect is less likely to be cancelled out, and a decrease in the operation efficiency due to the demagnetizing field is prevented. For this reason, it is possible to achieve sufficient antenna properties by using only the vibration antenna device 100. In particular, by causing the hard axis direction Aₕ of the magnetic layer 130 to match the vibration direction (Z-axis direction) of the piezoelectric layer 110, the operation efficiency can be maximized.

Regarding the arrangement of the piezoelectric layer 110 and the magnetic layer 130, by alternately arranging the piezoelectric layer 110 and the magnetic layer 130 in the direction (X-axis direction) perpendicular to the vibration direction (Z-axis direction) of the piezoelectric layer 110, the magnetic layer 130 is sandwiched between two piezoelectric layers 110. As a result, stress is transmitted to the magnetic layer 130 from the piezoelectric layers 110 on both sides, and thus, stress is transmitted to the central portion even if the width (X-axis direction) of the magnetic layer 130 is increased. Therefore, it is possible to increase the width of the magnetic layer 130 and improve the output of electromagnetic waves emitted from the magnetic layer 130.

### Regarding Hard Axis Direction of Magnetic Layer

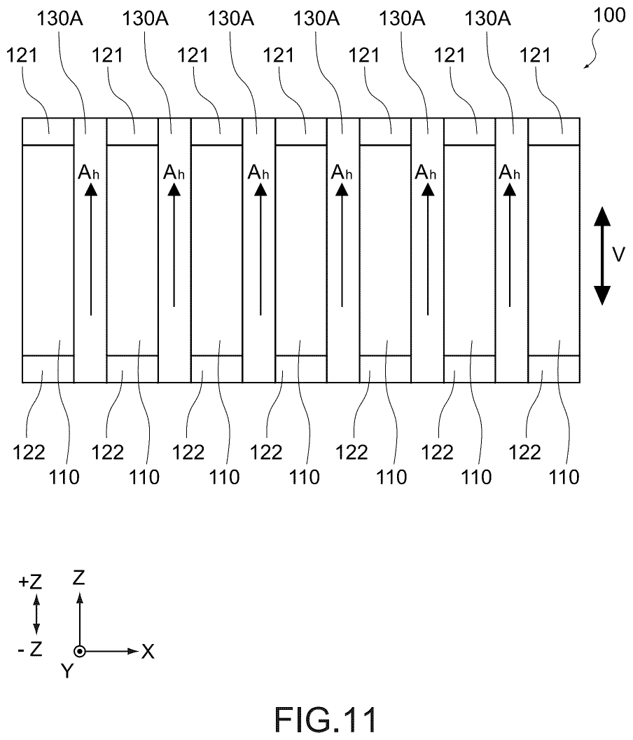

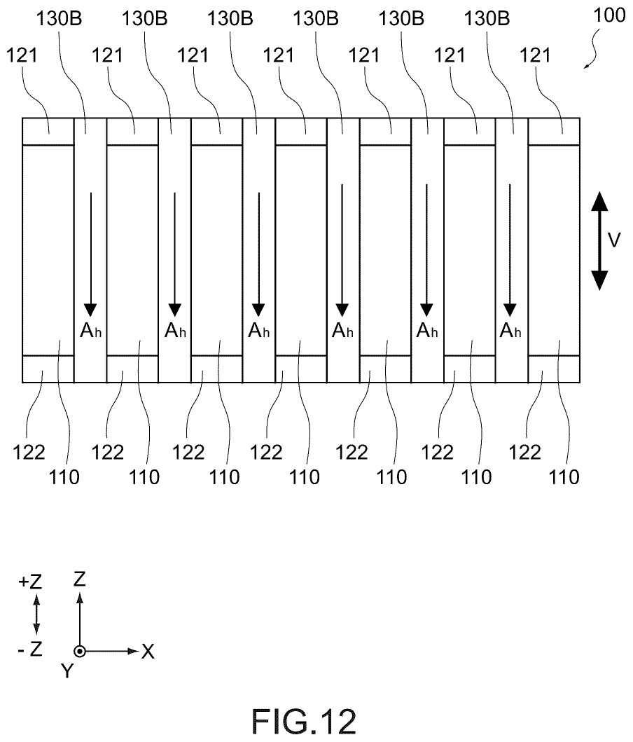

The hard axis direction Aₕ of the magnetic layer 130 suitably matches the vibration direction (Z-axis direction) of the piezoelectric layer 110. Further, one vibration antenna device 100 suitably includes the magnetic layers 130 having the hard axis directions Aₕ opposite to each other. FIG. 11 and FIG. 12 are each a schematic diagram showing the hard axis direction Aₕ of the magnetic layer 130 included in the vibration antenna device 100. As shown in FIG. 11, the magnetic layer 130 may include a magnetic layer 130A having the hard axis direction Aₕ that is the +Z direction. Further, as shown in FIG. 12, the magnetic layer 130 may include a magnetic layer 130B having the hard axis direction Aₕ that is the −Z direction.

As shown in FIG. 11 or FIG. 12, when the vibration antenna device 100 includes the magnetic layer 130A and the magnetic layer 130B having the hard axis directions Aₕ opposite to each other, the magnetic layer 130 that responds to the displacement of the piezoelectric layer 110 in the Z-axis direction (+Z direction or −Z direction) differs. Specifically, the magnetic layer 130A responds to generate a magnetic field when the piezoelectric layer 110 is displaced in the +Z direction, and the magnetic layer 130B responds to generate a magnetic field when the piezoelectric layer 110 is displaced in the −Z direction. Therefore, the magnetic layer 130 suitably includes both the magnetic layer 130A and the magnetic layer 130B.

### Regarding Various Configurations of Vibration Antenna Device

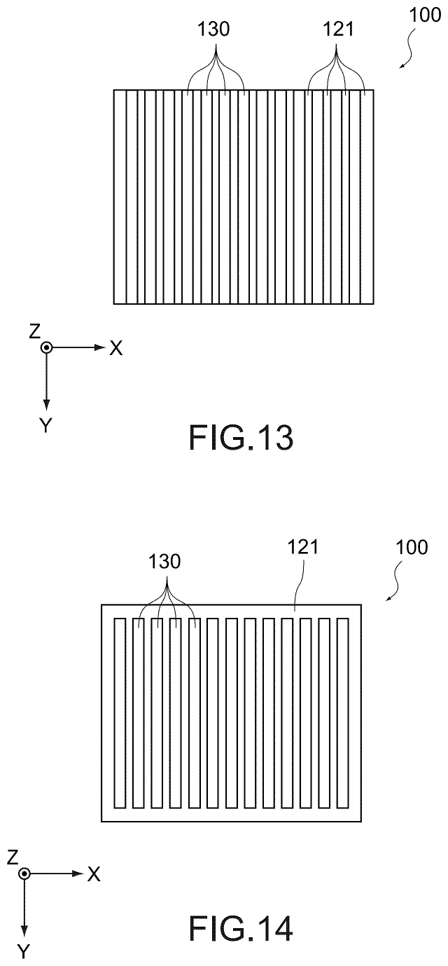

The plane shape of the vibration antenna device 100 as viewed from the vibration direction (Z-axis direction) of the piezoelectric layer 110 will be described. FIG. 13 to FIG. 15 are each a plan view of the vibration antenna device 100. Note that in each figure, the upper electrode 121 is formed in a plane shape similar to that of the piezoelectric layer 110 (see FIG. 4), i.e., the plane shape of the upper electrode 121 corresponds to the plane shape of the piezoelectric layer 110.

As shown in FIG. 13, the vibration antenna device 100 may include the plurality of piezoelectric layers 110 and the plurality of magnetic layers 130 alternately arranged in the direction (X-axis direction) perpendicular to the vibration direction (Z-axis direction) of the piezoelectric layer 110. Further, as shown in FIG. 14, the piezoelectric layer 110 may be one member connected at the peripheral edge portions.

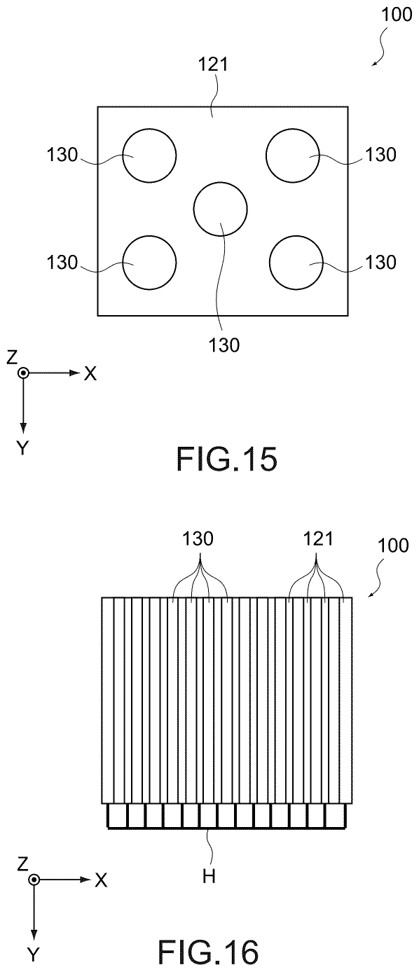

Further, the piezoelectric layer 110 and the magnetic layer 130 do not necessarily need to have a plate-like shape. As shown in FIG. 15, the magnetic layer 130 may have an island-shaped plane shape, and the piezoelectric layer 110 may have a plane shape surrounding the magnetic layer 130. The magnetic layer 130 does not necessarily need to have the circular shape shown in the figure, and may have a polygonal shape, a curved shape, a spiral shape, a lattice shape, an irregular shape, or the like. In these configurations as well, the vibration antenna device 100 suitably includes the magnetic layer 130A having the hard axis direction Aₕ that is the +Z direction and the magnetic layer 130B having the hard axis direction Aₕ that is the −Z direction.

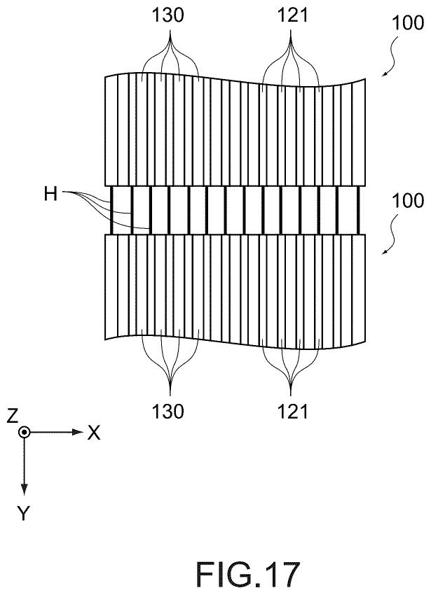

Next, the electrical connection of the vibration antenna device 100 will be described. FIG. 16 and FIG. 17 are each a schematic diagram showing the electrical connection of the vibration antenna device 100. As shown in FIG. 16, in one vibration antenna device 100, the upper electrode 121 may be electrically connected to another upper electrode 121 with a wire H. Although all of the upper electrodes 121 are connected in the figure, only some of the upper electrodes 121 may be connected. Similarly, the lower electrode 122 may be electrically connected to another lower electrode 122. Further, as shown in FIG. 17, the upper electrodes 121 may be electrically connected to those in another vibration antenna device 100 with the wire H. Although all of the upper electrodes 121 are connected in the figure, only some of the upper electrodes 121 may be connected. Similarly, the lower electrodes 122 may be connected to those in another vibration antenna device 100.

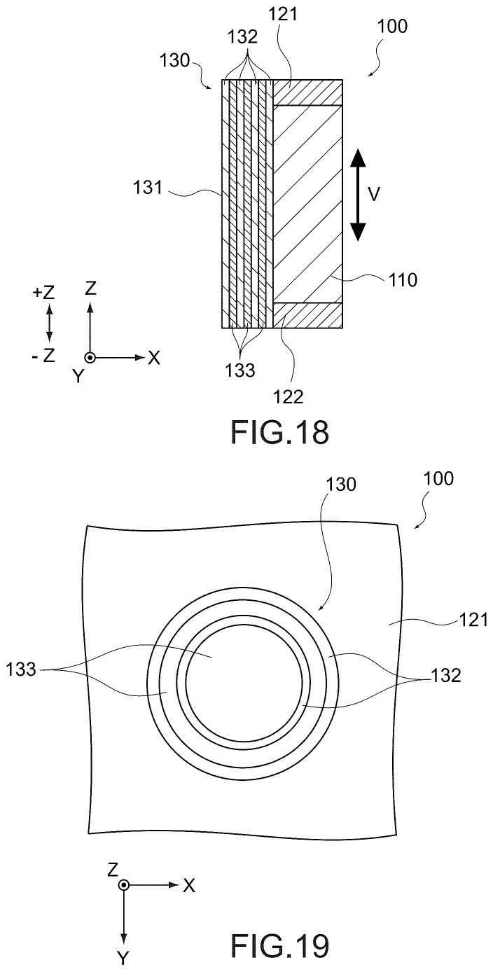

Next, another configuration of the magnetic layer 130 will be described. FIG. 18 is a cross-sectional view of a partial configuration of the vibration antenna device 100. As shown in the figure, the magnetic layer 130 may include a magnetic film 132 and an insulation film 133. The magnetic film 132 is a film formed of a magnetic material and has a film surface parallel to the main surface 131 of the magnetic layer 130. The insulation film 133 is a film formed of an insulating material and has a film surface parallel to the main surface 131 of the magnetic layer 130. Note that the insulation film 133 may be formed of a piezoelectric material or may be the same material as that of the piezoelectric layer 110.

The magnetic film 132 and the insulation film 133 are alternately arranged in the direction (X-axis direction) perpendicular to the vibration direction (Z-axis direction) of the piezoelectric layer 110, forming the magnetic layer 130. By configuring the magnetic layer 130 in this way, each magnetic film 132 becomes thinner, making the magnetic moment less likely to tilt in the X-axis direction and more likely to match the vibration direction (Z-axis direction) of the piezoelectric layer 110.

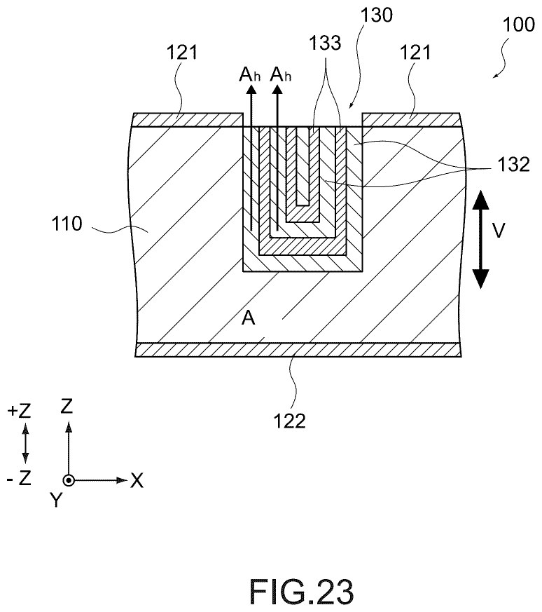

In the above-mentioned plane shape of the vibration antenna device 100 as well, the magnetic layer 130 may have such a configuration. FIG. 19 to FIG. 22 are each a plan view of part of the vibration antenna device 100, and FIG. 23 is a cross-sectional view of part of the vibration antenna device 100. As shown in FIG. 19, the magnetic layer 130 may include a plurality of annular magnetic films 132 arranged in concentric circles and the insulation film 133 disposed between the magnetic films 132. By configuring the magnetic layer 130 in this way, the magnetic moment is more easily aligned in an annular shape when stress is applied. Note that the number of annular magnetic films 132 may be one or three or more.

Note that FIG. 19 shows an example of the magnetic layer 130 shown in FIG. 15. That is, the circular magnetic layer 130 shown in FIG. 15 may be formed of only a magnetic material or may include the magnetic film 132 and the insulation film 133 as shown in FIG. 19.

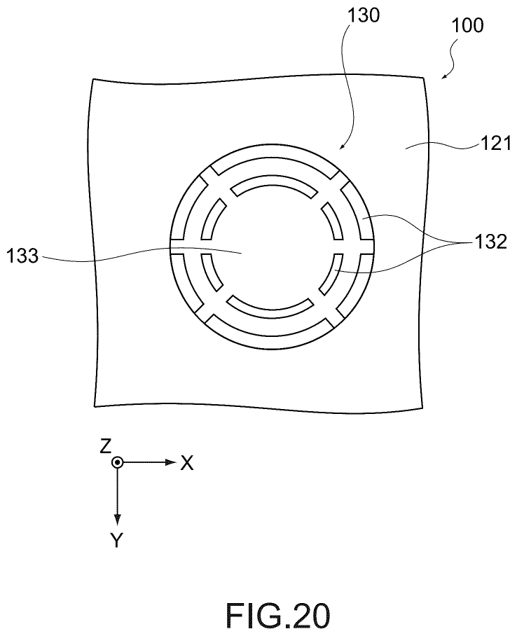

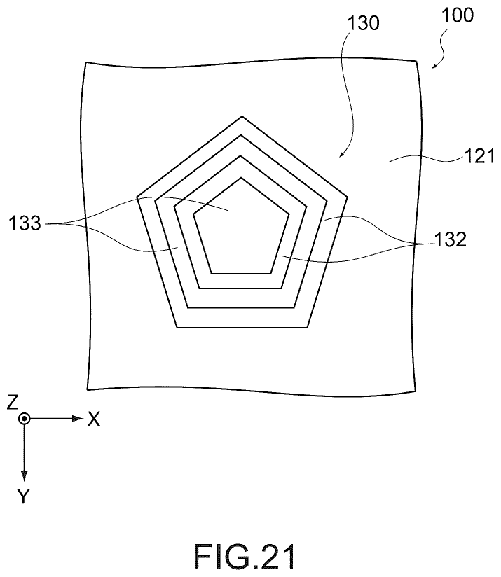

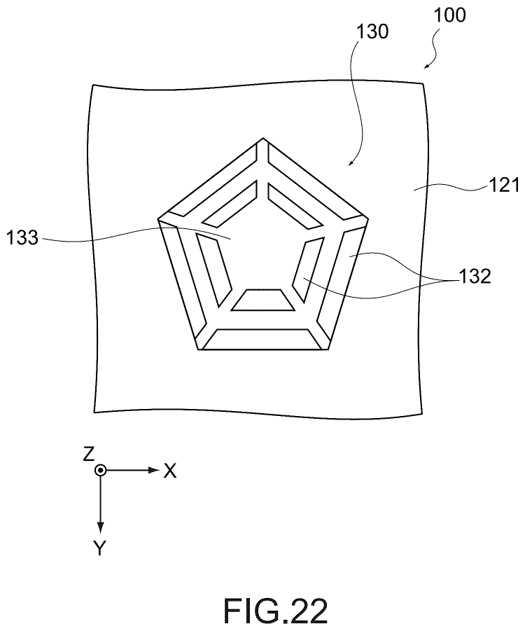

Further, each of the magnetic films 132 may be divided into a plurality of magnetic films 132 as shown in FIG. 20. Further, as shown in FIG. 21, the magnetic film 132 may have a polygonal ring-shaped plane shape. The polygon is not limited to a pentagon, and may be a triangle, a quadrilateral, a hexagon, or more. In this case as well, as shown in FIG. 22, each of the annular magnetic layers 130 may be divided into a plurality of magnetic layers 130. In addition, the plane shape of the magnetic film 132 is not particularly limited.

The magnetic layer 130 shown in FIG. 19 to FIG. 22 has a cross-sectional structure as shown in FIG. 23. The magnetic layer 130 includes the magnetic film 132 having the hard axis direction Aₕ that is the +Z direction. Further, the magnetic layer 130 may include the magnetic film 132 having the hard axis direction Ah that is the −Z direction. The magnetic layer 130 that includes the magnetic film 132 having the hard axis direction Aₕ that is the +Z direction responds to the displacement of the piezoelectric layer 110 in the +Z direction, and the magnetic layer 130 that includes the magnetic film 132 having the hard axis direction Ah that is the −Z direction responds to the displacement of the piezoelectric layer 110 in the −Z direction.

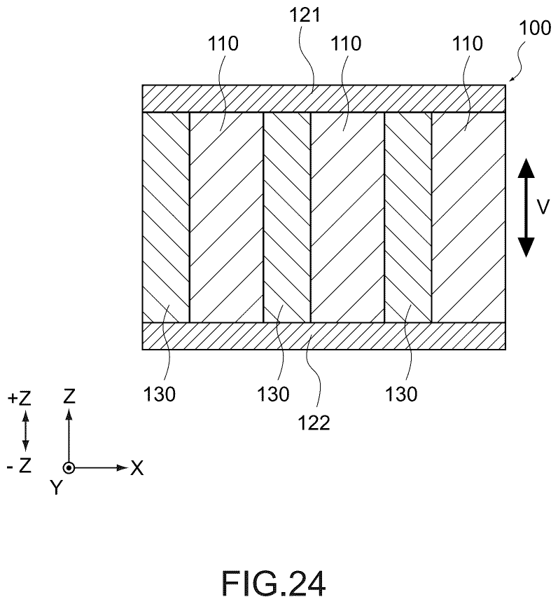

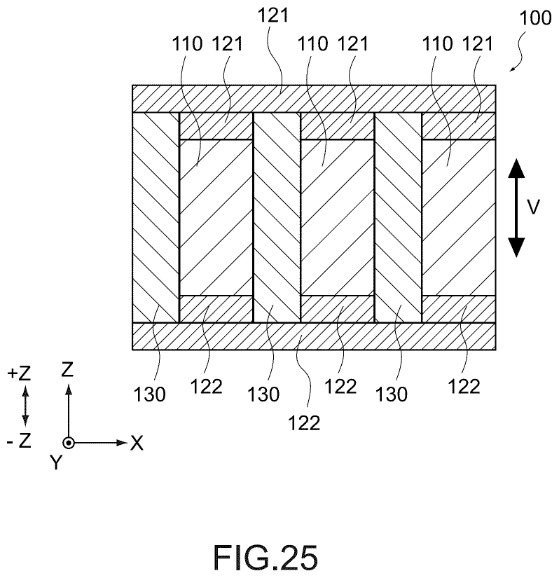

FIG. 24 and FIG. 25 are each a perspective view of a partial configuration of the vibration antenna device 100. As shown in these figures, the upper electrode 121 and the lower electrode 122 may be provided so as to face each other with the magnetic layer 130 as well as the piezoelectric layer 110 sandwiched therebetween. In this case as well, the piezoelectric layer 110 and the magnetic layer 130 operate in the same manner as when the upper electrode 121 and the lower electrode 122 face each other with only the piezoelectric layer 110 sandwiched therebetween.

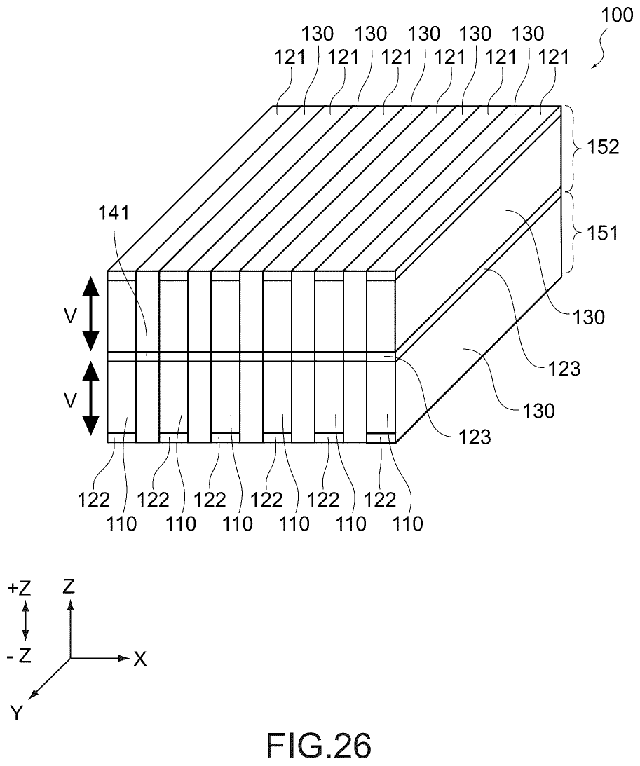

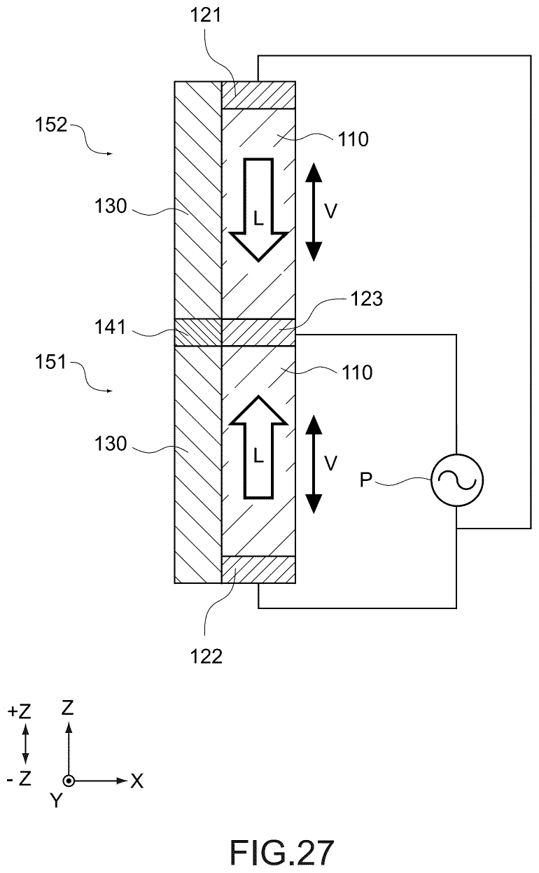

Next, a layered structure of the vibration antenna device 100 will be described. FIG. 26 is a perspective view of the vibration antenna device 100 having a layered structure, and FIG. 27 is a cross-sectional view of the partial configuration. As shown in these figures, the vibration antenna device 100 may include a first layer 151 and a second layer 152. Each of the first layer 151 and the second layer 152 includes the piezoelectric layer 110 and the magnetic layer 130 alternately positioned in the direction (X-axis direction) perpendicular to the vibration direction (Z-axis direction) of the piezoelectric layer 110. Further, the first layer 151 and the second layer 152 are stacked in the vibration direction (Z-axis direction) of the piezoelectric layer 110 and configured such that the piezoelectric layers 110 are aligned in the Z-axis direction and the magnetic layers 130 are aligned in the Z-axis direction between layers.

As shown in FIG. 27, between the first layer 151 and the second layer 152, a central electrode 123 is provided between the piezoelectric layers 110. The central electrode 123 functions as an upper electrode in the first layer 151 and as a lower electrode in the second layer 152. Further, between the first layer 151 and the second layer 152, an interlayer insulation layer 141 that insulates the magnetic layers 130 from each other is provided between the magnetic layers 130. The interlayer insulation layer 141 does not necessarily need to be provided, and the magnetic layers 130 may be in contact with each other.

Further, as shown in FIG. 27, between the first layer 151 and the second layer 152, the polarization directions of the piezoelectric layers 110 indicated by arrows L are opposed to each other. As a result, when a voltage is applied to each electrode from the power source P, the displacement directions of the piezoelectric layers 110 match between the first layer 151 and the second layer 152, i.e., the displacement is not cancelled out, which is suitable.

Each of the first layer 151 and the second layer 152 is configured such that the easy axis direction Aₑ and the hard axis direction Aₕ of the magnetic layer 130 of each layer are positioned in the plane (Y-Z plane) parallel to the vibration direction (Z-axis direction). As a result, the magnetization of the magnetic layer 130 by the Villari effect is less likely to be cancelled out by the demagnetizing field, and a decrease in the operation efficiency due to the demagnetizing field is prevented. Further, it is more suitable that the magnetic layer 130 of each layer has the hard axis direction Aₕ that matches the vibration direction (Z-axis direction) of the piezoelectric layer 110. Further, by stacking the first layer 151 and the second layer 152, the displacement amount of resonance increases and the intensity of emitted electromagnetic waves is improved, which is suitable. Note that although the vibration antenna device 100 that includes two layers, i.e., the first layer 151 and the second layer 152, has been described here, the vibration antenna device 100 may include three or more layers.

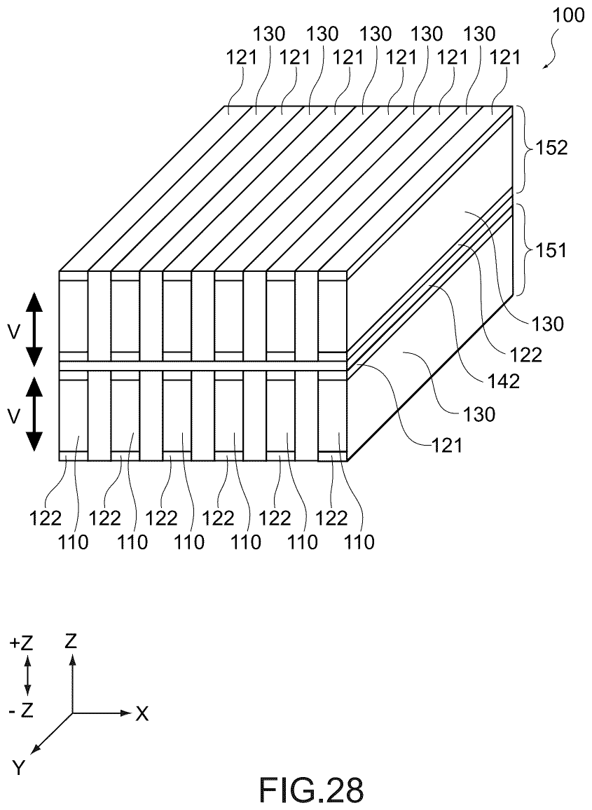

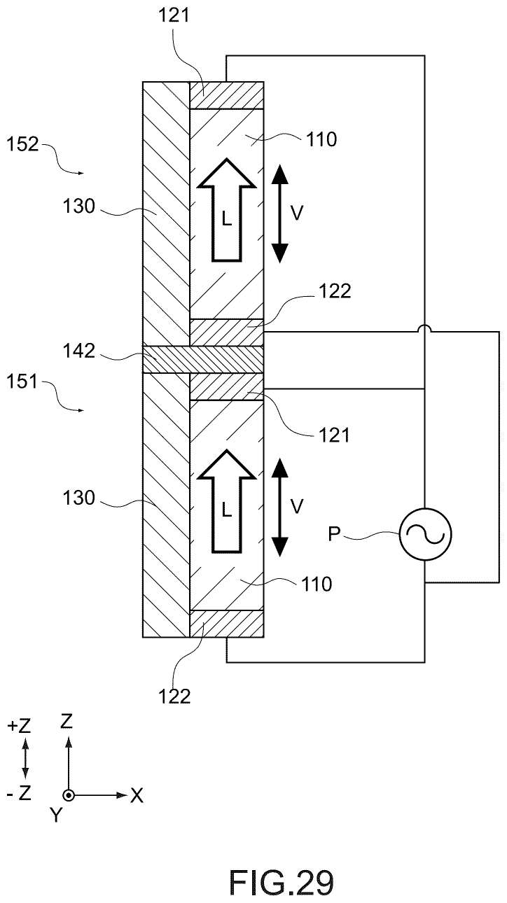

FIG. 28 is a perspective view of the vibration antenna device 100 having another layered structure, and FIG. 29 is a cross-sectional view of the partial configuration. This configuration is different from the configuration shown in FIG. 26 and FIG. 27 in that the upper electrode 121 and the lower electrode 122 are provided in each of the first layer 151 and the second layer 152, and an interlayer insulation layer 142 is provided between the first layer 151 and the second layer 152. The interlayer insulation layer 142 insulates the upper electrode 121 and the lower electrode 122 from each other between the first layer 151 and the second layer 152, and insulates the magnetic layers 130 from each other. As shown in FIG. 29, between the first layer 151 and the second layer 152, the polarization directions of the piezoelectric layers 110 indicated by arrows L are the same direction. As a result, when a voltage is applied to each electrode from the power source P, the displacement directions of the piezoelectric layers 110 match between the first layer 151 and the second layer 152, i.e., the displacement is not cancelled out, which is suitable.

With this configuration as well, a decrease in the operation efficiency of the magnetic layer 130 due to the demagnetizing field is prevented, and the displacement amount of resonance increases by stacking the first layer 151 and the second layer 152, which is suitable. In this configuration as well, the vibration antenna device 100 may have three or more layers.

### Regarding Vibration Antenna Device and Substrate

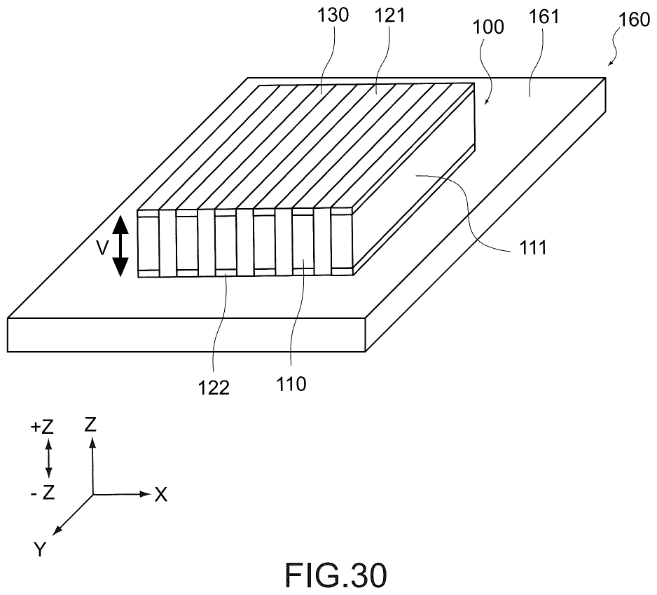

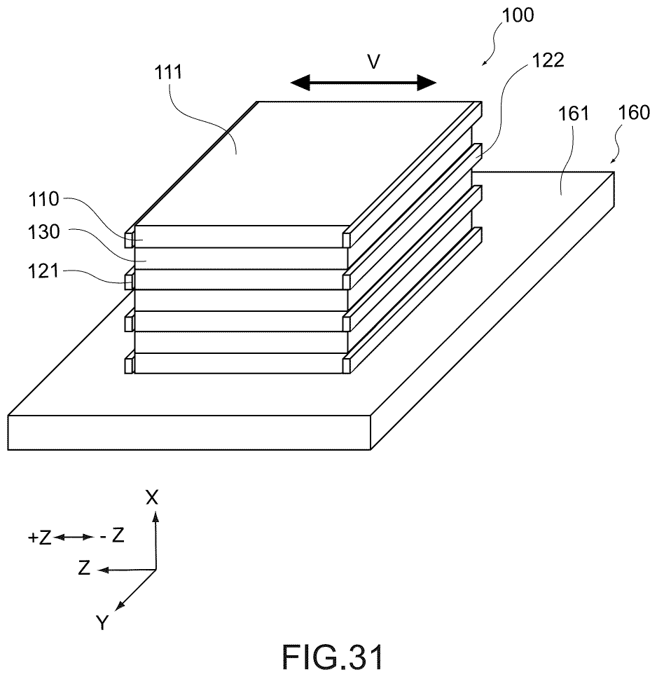

The vibration antenna device 100 can be provided on a substrate. FIG. 30 and FIG. 31 are each a perspective view of the vibration antenna device 100 provided on a substrate 160. As shown in these figures, the substrate 160 has a main surface 161.

As shown in FIG. 30, the vibration antenna device 100 is provided such that the main surface 111 of the piezoelectric layer 110 and the main surface 131 of the magnetic layer 130 are perpendicular to the main surface 161. In this case, the main surface 161 is a surface parallel to the plane (X-Y plane) perpendicular to the vibration direction (Z-axis direction) of the piezoelectric layer 110.

Further, as shown in FIG. 31, the vibration antenna device 100 may be provided such that the main surface 111 of the piezoelectric layer 110 and the main surface 131 of the magnetic layer 130 are parallel to the main surface 161. In this case, the main surface 161 is a surface parallel to the plane (Y-Z plane) parallel to the vibration direction (Z-axis direction) of the piezoelectric layer 110. Note that the vibration antenna device 100 can be provided on the substrate 160 by crystal growth or the like. Further, the vibration antenna device 100 prepared elsewhere may be mounted on the substrate 160.

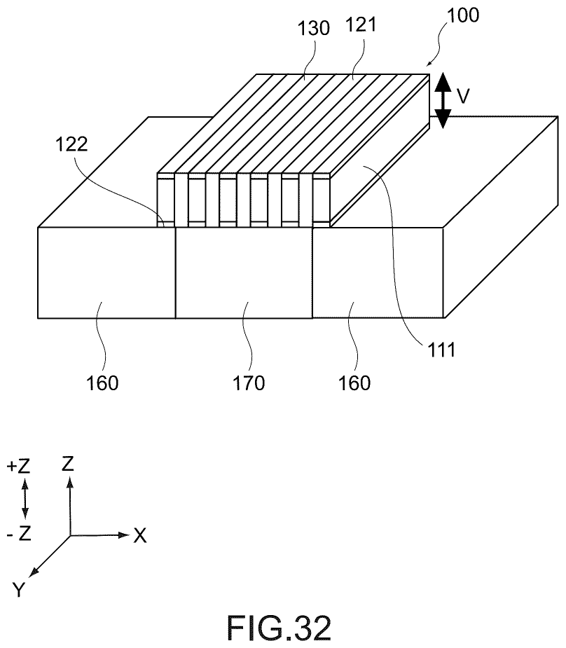

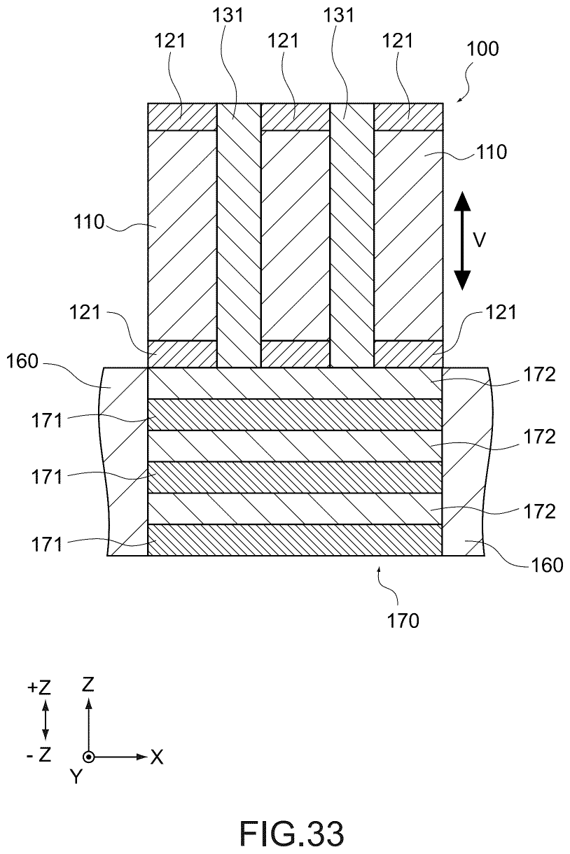

Further, the substrate 160 may be provided with an acoustic mirror, and the vibration antenna device 100 may be provided adjacent to the acoustic mirror. FIG. 32 is a perspective view of the vibration antenna device 100 provided adjacent to the acoustic mirror 170, and FIG. 33 is a schematic diagram thereof. As shown in FIG. 33, the acoustic mirror 170 includes a high modulus film 171 formed of a high modulus material and a low modulus film 172 formed of a low modulus material. The high modulus film 171 and the low modulus film 172 are each a film having a film surface parallel to the plane (X-Y plane) perpendicular to the vibration direction (Z-axis direction) of the piezoelectric layer 110.

As the high modulus material and the low modulus material, two types with a high ratio between high and low elastic moduli, of manganese (Mn), bismuth (Bi), cesium (Ce), barium (Ba), yttrium (Y), zirconium (Zr), antimony (Sb), hafnium (Hf), uranium (U), strontium (Sr), lead (Pb), rhenium (Re), tungsten (W), osmium (Os), iridium (Ir), platinum (Pt), ruthenium (Ru), molybdenum (Mo), rhodium (Rh), gold (Au), sodium (Na), magnesium (Mg), calcium (Ca), aluminum (Al), silver (Ag), copper (Cu), iron (Fe), niobium (Nb), silicon dioxide (SiO₂), aluminum oxide (Al₂O₃), and the like, can be used.

The vibration antenna device 100 is adjacent to the acoustic mirror 170 in the vibration direction (Z-axis direction) of the piezoelectric layer 110. When the vibration antenna device 100 is adjacent to the acoustic mirror 170, elastic waves generated by the resonance of the vibration antenna device 100 are reflected by the acoustic mirror 170. Thus, the attenuation of elastic waves by the substrate 160 is suppressed as compared with the case where the vibration antenna device 100 is provided on the substrate 160.

Note that the configuration of the acoustic mirror 170 differs depending on the thickness (Z-axis direction) of the piezoelectric layer 110. In the case where the thickness (Z-axis direction) of the piezoelectric layer 110 is one-quarter of a wavelength λ of the elastic wave, the configuration shown in FIG. 32 is adopted. Meanwhile, in the case where the thickness (Z-axis direction) of the piezoelectric layer 110 is half the wavelength λ of the elastic wave, the configuration obtained by interchanging the high modulus film 171 and the low modulus film 172 in the configuration shown in FIG. 32 is adopted. The numbers of high modulus films 171 and low modulus films 172 included in the acoustic mirror 170 are not particularly limited, and only need to be one or more.

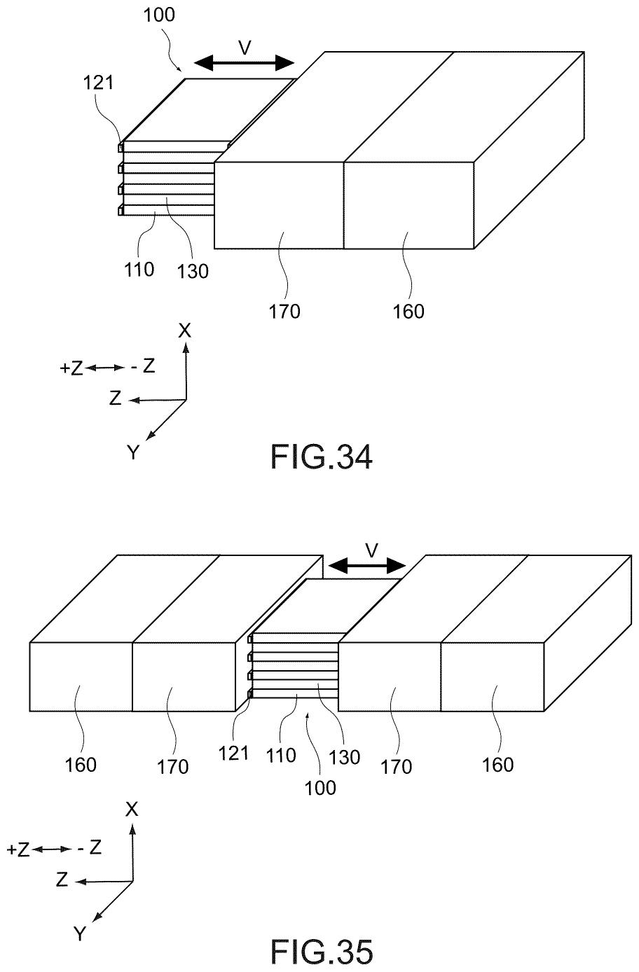

Further, the vibration antenna device 100 and the acoustic mirror 170 may be arranged as follows. FIG. 34 and FIG. 35 are each a perspective view of the vibration antenna device 100 and the acoustic mirror 170. As shown in FIG. 34, the vibration antenna device 100 may have one surface adjacent to the acoustic mirror 170 in the vibration direction (Z-axis direction) of the piezoelectric layer 110. Further, as shown in FIG. 35, the vibration antenna device 100 may have both surfaces adjacent to the acoustic mirrors 170 in the vibration direction (Z-axis direction) of the piezoelectric layer 110.

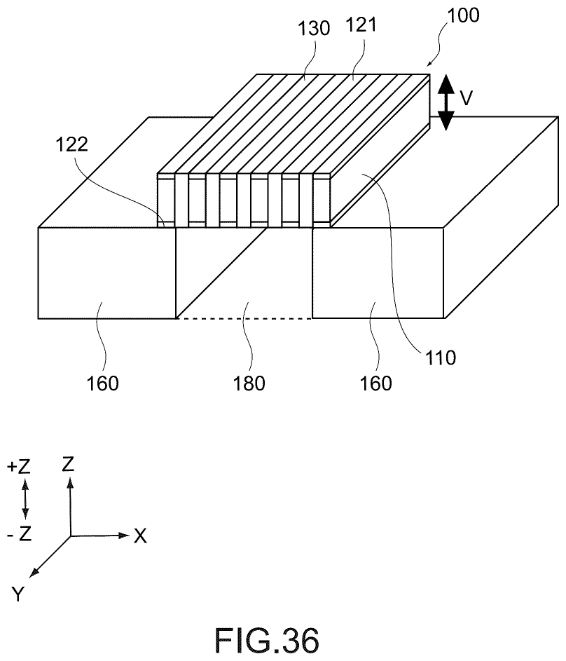

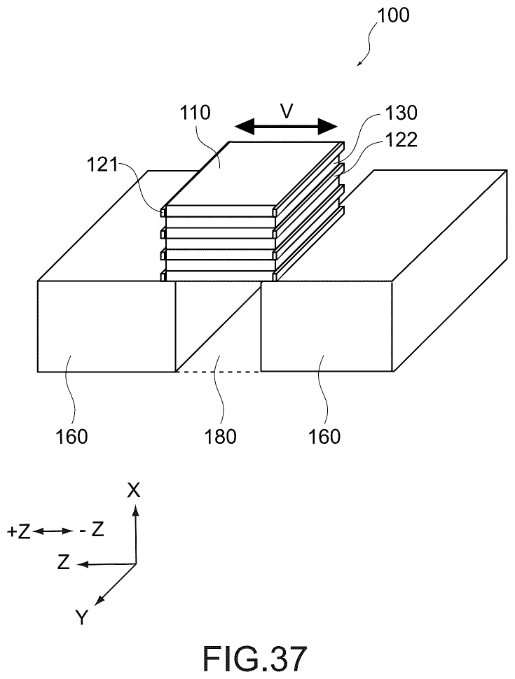

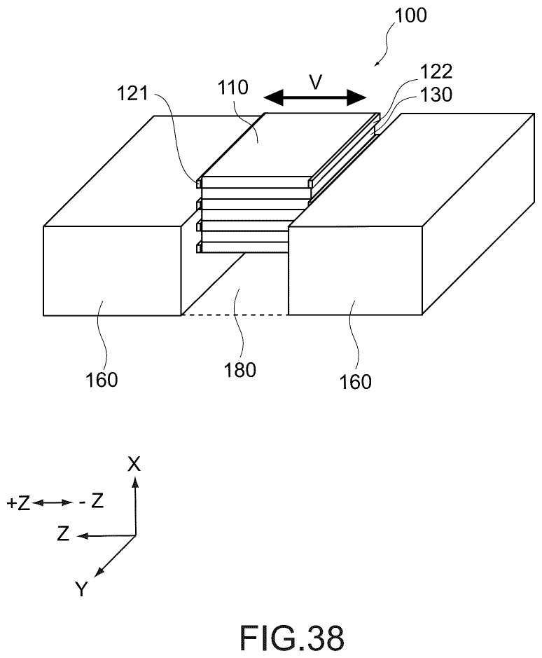

Further, the substrate 160 may be provided with a gap, and the vibration antenna device 100 may be provided adjacent to the gap. FIG. 36 to FIG. 38 are each a perspective view of the vibration antenna device 100 provided adjacent to a gap 180. As shown in FIG. 36, the vibration antenna device 100 may be adjacent to the gap 180 in the vibration direction (Z-axis direction) of the piezoelectric layer 110. Further, as shown in FIG. 37 and FIG. 38, the vibration antenna device 100 may be adjacent to the gap 180 in the direction (X-axis direction) perpendicular to the vibration direction (Z-axis direction) of the piezoelectric layer 110. When the vibration antenna device 100 is adjacent to the gap 180, the elastic waves generated by the resonance of the vibration antenna device 100 are not absorbed by the substrate 160, and the attenuation of elastic waves by the substrate 160 is suppressed as compared with the case where the vibration antenna device 100 is provide on the substrate 160.

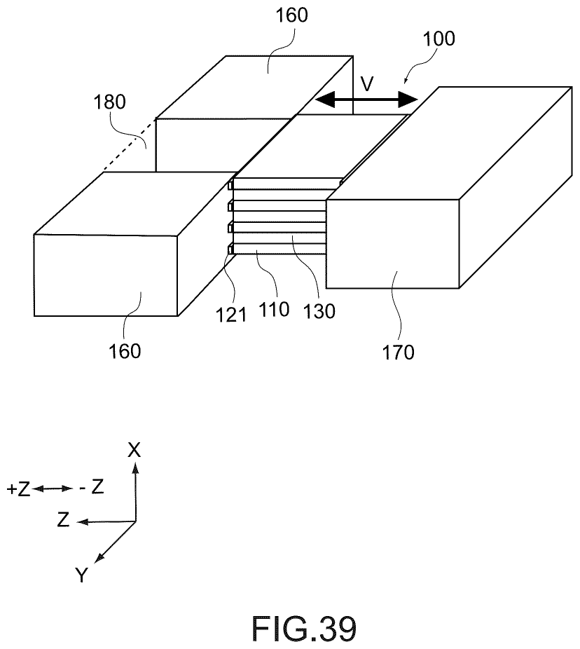

Further, the substrate 160 may be provided with an acoustic mirror and a gap, and the vibration antenna device 100 may be provided adjacent to these. FIG. 39 a perspective view of the vibration antenna device 100 provided adjacent to the acoustic mirror 170 and the gap 180. As shown in the figure, the vibration antenna device 100 may have one surface adjacent to the acoustic mirror 170 and the other surface adjacent to the gap 180 in the vibration direction (Z-axis direction) of the piezoelectric layer 110. In this case as well, the acoustic mirror 170 and the gap 180 suppress the attenuation of elastic waves.

### Regarding Vibration Antenna Device Array

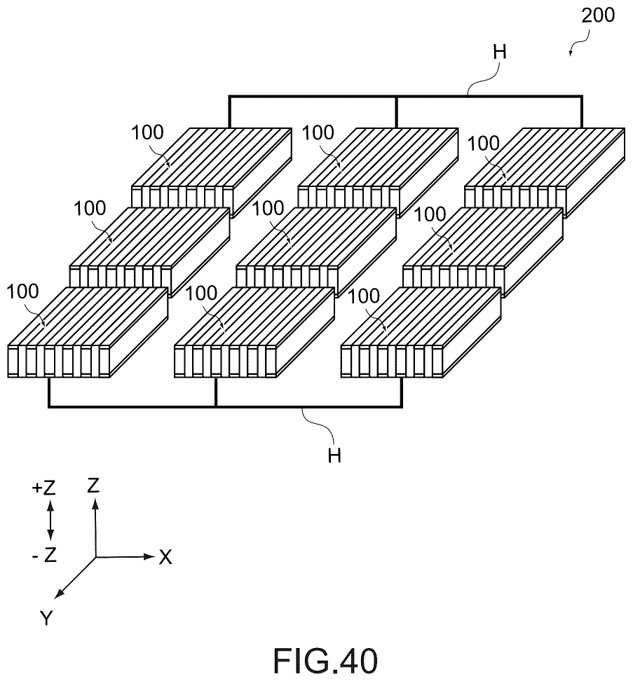

The vibration antenna device 100 can form an array. FIG. 40 is a schematic diagram of a vibration antenna device array 200 including the vibration antenna device 100. As shown in the figure, the vibration antenna device array 200 includes a plurality of vibration antenna devices 100, and each of the vibration antenna devices 100 is electrically connected with the wire H. Specifically, between the vibration antenna devices 100, the upper electrode 121 are connected to each other and the lower electrode 122 are also connected to each other. The connection of the vibration antenna devices 100 may be either in series or in parallel. By electrically connecting the plurality of vibration antenna devices 100, it is possible to improve the intensity of electromagnetic waves to be transmitted and adjust the impedance. Note that the number of vibration antenna devices 100 constituting the vibration antenna device array 200 is not particularly limited and only needs to be two or more.

### Regarding Electronic Apparatus

The vibration antenna device 100 can be mounted on an electronic apparatus. The electronic apparatus on which the vibration antenna device 100 is mounted is not particularly limited, but an electronic apparatus requiring miniaturization, such as wireless earphones, is particularly suitable. As described above, the vibration antenna device 100 can be used as a device for Bluetooth (registered trademark) and other wireless communication. Further, the vibration antenna device 100 can also be used as a power receiving device for wireless power transmission or an energy harvester that generates electric power from vibration.

### Regarding Present Disclosure

The effects described in the present disclosure are merely examples and are not limited, and additional effects may be achieved. The description of the plurality of effects described above does not necessarily mean that these effects are exhibited simultaneously. It means that at least one of the effects described above can be achieved in accordance with the conditions or the like, and there is a possibility that an effect that is not described in the present disclosure is exhibited. Further, at least two feature portions of the feature portions described in the present disclosure may be arbitrarily combined with each other.

It should be noted that the present technology may also take the following configurations.
(1) A vibration antenna device, including:
a piezoelectric layer that is at least partially formed of a piezoelectric material and vibrates in a predetermined vibration direction;
a pair of electrodes that face each other across the piezoelectric layer; and
a magnetic layer that is at least partially formed of a magnetic material, is adjacent to the piezoelectric layer in a direction perpendicular to the vibration direction, and has an easy axis direction and a hard axis direction positioned in a plane parallel to the vibration direction.
(2) The vibration antenna device according to (1) above, in which
the hard axis direction of the magnetic layer matches the vibration direction.
(3) The vibration antenna device according to (2) above, in which
the magnetic material is a material having a positive magnetostriction constant, and the easy axis direction is perpendicular to the vibration direction.
(4) The vibration antenna device according to (2) above, in which
the magnetic material is a material having a negative magnetostriction constant, and the easy axis direction is parallel to the vibration direction.
(5) The vibration antenna device according to any one of (1) to (4) above, further including
a plurality of the piezoelectric layers and a plurality of the magnetic layers,
the plurality of piezoelectric layers and the plurality of magnetic layers being alternately arranged in the direction perpendicular to the vibration direction.
(6) The vibration antenna device according to (5) above, in which
the plurality of magnetic layers includes the magnetic layer having the hard axis direction that matches a first direction parallel to the vibration direction and the magnetic layer having the hard axis direction that matches a second direction, the second direction being parallel to the vibration direction and opposed to the first direction.
(7) The vibration antenna device according to any one of (1) to (6) above, in which
the piezoelectric layer has a polarization direction in a first direction that is parallel to the vibration direction or a second direction that is parallel to the vibration direction and opposed to the first direction.
(8) The vibration antenna device according to any one of (1) to (7) above, in which
the pair of electrodes face each other with the vibration direction as an opposing direction.
(9) The vibration antenna device according to any one of (1) to (8) above, in which
the piezoelectric layer has a plate-like shape whose main surface is parallel to the vibration direction, and
the magnetic layer has a plate-like shape whose main surface is parallel to the vibration direction.
(10) The vibration antenna device according to (5) above, further including
a plurality of layers stacked in the vibration direction,
each of the plurality of layers including the plurality of piezoelectric layers and the plurality of magnetic layers alternately arranged in the direction perpendicular to the vibration direction.
(11) The vibration antenna device according to (10) above, further including
an interlayer insulation layer that is formed of an insulating material and arranged between the plurality of layers.
(12) The vibration antenna device according to any one of (1) to (11) above, which is formed on a substrate whose main surface is a plane perpendicular to the vibration direction.
(13) The vibration antenna device according to any one of (1) to (11) above, which is formed on a substrate whose main surface is a plane parallel to the vibration direction.
(14) The vibration antenna device according to any one of (1) to (13) above, in which
the magnetic layer includes a plurality of magnetic films that is formed of a magnetic material and an insulation layer that is formed of an insulation material and arranged between he plurality of magnetic films.
(15) The vibration antenna device according to any one of (1) to (14) above, in which
the pair of electrodes are formed of a magnetic material.
(16) The vibration antenna device according to any one of (1) to (15) above, in which
the pair of electrodes face each other further across the magnetic layer.
(17) The vibration antenna device according to any one of (1) to (16) above, which is provided on a substrate in which an acoustic mirror is provided and adjacent to the acoustic mirror.
(18) The vibration antenna device according to any one of (1) to (17) above, which is provided on a substrate in which a gap is provided and adjacent to the gap.
(19) A vibration antenna device array, including:
a plurality of vibration antenna devices,
each of the vibration antenna devices including
   a piezoelectric layer that is at least partially formed of a piezoelectric material and vibrates in a predetermined vibration direction,
   a pair of electrodes that face each other across the piezoelectric layer, and
   a magnetic layer that is at least partially formed of a magnetic material, is adjacent to the piezoelectric layer in a direction perpendicular to the vibration direction, and has an easy axis direction and a hard axis direction positioned in a plane parallel to the vibration direction,
the pair of electrodes being electrically connected between the plurality of vibration antenna devices.
(20) An electronic apparatus, including:
a vibration antenna device including
   a piezoelectric layer that is at least partially formed of a piezoelectric material and vibrates in a predetermined vibration direction,
   a pair of electrodes that face each other across the piezoelectric layer, and
   a magnetic layer that is at least partially formed of a magnetic material, is adjacent to the piezoelectric layer in a direction perpendicular to the vibration direction, and has an easy axis direction and a hard axis direction positioned in a plane parallel to the vibration direction.

### Reference Signs List

100 vibration antenna device
110 piezoelectric layer
120 electrode
121 upper electrode
122 lower electrode
130 magnetic layer
   the insulation film 133 magnetic film
134 insulation film
141 interlayer insulation layer
142 interlayer insulation layer
151 first layer
152 second layer
160 substrate
170 acoustic mirror
180 gap

1. A vibration antenna device, comprising:
a piezoelectric layer that is at least partially formed of a piezoelectric material and vibrates in a predetermined vibration direction;
a pair of electrodes that face each other across the piezoelectric layer; and
a magnetic layer that is at least partially formed of a magnetic material, is adjacent to the piezoelectric layer in a direction perpendicular to the vibration direction, and has an easy axis direction and a hard axis direction positioned in a plane parallel to the vibration direction.

2. The vibration antenna device according to claim 1, wherein
the hard axis direction of the magnetic layer matches the vibration direction.

3. The vibration antenna device according to claim 2, wherein
the magnetic material is a material having a positive magnetostriction constant, and the easy axis direction is perpendicular to the vibration direction.

4. The vibration antenna device according to claim 2, wherein
the magnetic material is a material having a negative magnetostriction constant, and the easy axis direction is parallel to the vibration direction.

5. The vibration antenna device according to claim 1, further comprising
a plurality of the piezoelectric layers and a plurality of the magnetic layers,
the plurality of piezoelectric layers and the plurality of magnetic layers being alternately arranged in the direction perpendicular to the vibration direction.

6. The vibration antenna device according to claim 5, wherein
the plurality of magnetic layers includes the magnetic layer having the hard axis direction that matches a first direction parallel to the vibration direction and the magnetic layer having the hard axis direction that matches a second direction, the second direction being parallel to the vibration direction and opposed to the first direction.

7. The vibration antenna device according to claim 1, wherein
the piezoelectric layer has a polarization direction in a first direction that is parallel to the vibration direction or a second direction that is parallel to the vibration direction and opposed to the first direction.

8. The vibration antenna device according to claim 1, wherein
the pair of electrodes face each other with the vibration direction as an opposing direction.

9. The vibration antenna device according to claim 1, wherein
the piezoelectric layer has a plate-like shape whose main surface is parallel to the vibration direction, and
the magnetic layer has a plate-like shape whose main surface is parallel to the vibration direction.

10. The vibration antenna device according to claim 5, further comprising
a plurality of layers stacked in the vibration direction,
each of the plurality of layers including the plurality of piezoelectric layers and the plurality of magnetic layers alternately arranged in the direction perpendicular to the vibration direction.

11. The vibration antenna device according to claim 10, further comprising
an interlayer insulation layer that is formed of an insulating material and arranged between the plurality of layers.

12. The vibration antenna device according to claim 1, which is formed on a substrate whose main surface is a plane perpendicular to the vibration direction.

13. The vibration antenna device according to claim 1, which is formed on a substrate whose main surface is a plane parallel to the vibration direction.

14. The vibration antenna device according to claim 1, wherein
the magnetic layer includes a plurality of magnetic films that is formed of a magnetic material and an insulation layer that is formed of an insulation material and arranged between he plurality of magnetic films.

15. The vibration antenna device according to claim 1, wherein
the pair of electrodes are formed of a magnetic material.

16. The vibration antenna device according to claim 1, wherein
the pair of electrodes face each other further across the magnetic layer.

17. The vibration antenna device according to claim 1, which is provided on a substrate in which an acoustic mirror is provided and adjacent to the acoustic mirror.

18. The vibration antenna device according to claim 1, which is provided on a substrate in which a gap is provided and adjacent to the gap.

19. A vibration antenna device array, comprising:
a plurality of vibration antenna devices,
each of the vibration antenna devices including
a piezoelectric layer that is at least partially formed of a piezoelectric material and vibrates in a predetermined vibration direction,
a pair of electrodes that face each other across the piezoelectric layer, and
a magnetic layer that is at least partially formed of a magnetic material, is adjacent to the piezoelectric layer in a direction perpendicular to the vibration direction, and has an easy axis direction and a hard axis direction positioned in a plane parallel to the vibration direction,
the pair of electrodes being electrically connected between the plurality of vibration antenna devices.

20. An electronic apparatus, comprising:
a vibration antenna device including
a piezoelectric layer that is at least partially formed of a piezoelectric material and vibrates in a predetermined vibration direction,
a pair of electrodes that face each other across the piezoelectric layer, and
a magnetic layer that is at least partially formed of a magnetic material, is adjacent to the piezoelectric layer in a direction perpendicular to the vibration direction, and has an easy axis direction and a hard axis direction positioned in a plane parallel to the vibration direction.
